(19) United States
(12) Patent Application Publication
(10) Pub. No.: US 2005/0053693 A1
(43) Pub. Date: Mar. 10, 2005

(54) Method to improve meat tenderness by accelerating the postmortem aging of muscle

(76) Inventors: William E. Julien, Omaha, NE (US); Tony Rossman, Castle Rock, CO (US); Douglas E. Pamp, Garvin, MN (US)

Correspondence Address: Paul M. Denk, Ste. 170, 763 S. New Ballas Road, St. Louis, MO, 63141, US

(21) Appl. No.: 10/933,858

(22) Filed: Sep. 4, 2004

Related U.S. Application Data
(60) Provisional application No. 60/500,984, filed on Sep. 9, 2003.

(51) Int. Cl. A01K 1/00

(52) U.S. Cl. 426/2

(57) ABSTRACT

This invention provides a feed additive for ruminant and other animals, as well as pork and poultry, that includes a balance between positively charged particles and negatively charged particles, to cause the diet to have a negative cation/anion balance. The composition may be obtained from either glutamic acid fermentation solubles, corn fermentation solubles, or other related fermentation solubles, or a mixture thereof. The composition enhances ionic activity through the addition of ionic sources such as ammonium or magnesium salts, and related salts, which together function as a feed additive to increase meat tenderness.

### CROSS REFERENCE TO RELATED APPLICATION

This non-provisional patent application claims priority to the provisional application for patent having Ser. No. 60/500,984, which was filed on Sep. 9, 2003.

### BACKGROUND OF THE INVENTION

Postmortem tenderization of beef, pork, and poultry has been shown to partially depend upon the release of calpain, a calcium activated protease. Calpain causes deterioration of myofibrillar structure, thus accelerating the postmortem aging process of muscle tissue. Calpain activity has been shown to be stimulated by the presence of increased levels of serum and consequently, intracellular calcium. In the laboratory, postmortem infusions of calcium solutions into muscle have demonstrated their value in tenderization. Under field conditions however, this method has proven to be infeasible. Nutritional interventions, such as feeding elevated levels of dietary calcium or feeding the animal supranutritional levels of vitamin D₃, a vitamin associated with enhanced calcium metabolism, have not proven effective in increasing tenderness. Considering the beef industry alone, inconsistency in tenderness costs the industry over $250 million in lost sales every year. A method whereby the apparent positive impact of high levels of intracellular calcium could provide a commercial advantage is much needed.

### SUMMARY OF THE INVENTION

The invention relates to a feed additive for ruminant and other animals. When used as a component in the diet formulated for this class of animal, the feed additive will improve beef tenderness. In the preferred embodiment of the invention, a source of dietary anions is fed to fattening beef cattle during the late stages of finishing. An ideal source of anions would be a blend of dried glutamic acid fermentation solubles and dried corn fermentation solubles; although other anionic sources such as ammonium or magnesium salts may be used. The consumed dietary anions will improve serum levels of calcium ions, which in turn, will increase intracellular levels of calcium which leads to accelerated calpain activity. Calpain, a calcium activated protease, accelerates the postmortem aging process that increases beef tenderness.

As a feed additive, the invention applies to ruminant, nonruminant, and monogastric food animals, and all classes of poultry. This feed additive, when added to the diet of an animal modifies the balance between positive charged particles (cations) and negatively charged particles (anions) so the diet has a negative cation/anion balance, i.e. more anions than cations. When used as a component in the diet formulated for these animals, the feed additive will improve meat tenderness. Ideally, the invention contemplates the usage of a composition, which is obtained from glutamic acid fermentation solubles, corn fermentation. solubles, other related solubles, or a blend thereof. The solubles may be blended with a carrier such as wheat middlings, or other middlings if desired, and then dried to a maximum moisture content of about 30% at temperatures not more than 900° F. but not less than 80° F. The moisture content will be approximately 14% for this feed additive. Alternatively, liquid glutamic acid fermentation solubles, liquid corn fermentation solubles, ammonium or magnesium salts or any other source of anions that can be introduced into the diet, such as hydrochloric acid, may also be used either alone, or blended with each other or blended with the ingredients defined within the preferred embodiment.

Feeding this mixture, as part of the diet during the later stages of fattening, will improve serum levels of calcium ions. Rising serum levels increase intracellular levels of calcium, accelerating calpain activity and the postmortem aging process. The acceleration increases meat tenderness.

In view of the deficiencies in the art as described above and other related goals well known in the art, one object of the present invention is to provide a feed additive that stimulates calcium metabolism in an animal.

Another object of the present invention is to provide a feed additive which improves meat tenderness of beef, pork, and poultry.

These and other objects may become apparent to those skilled in the art upon reviewing the subject matter of this invention as detailed herein.

### DESCRIPTION OF THE INVENTION

The above objects have been obtained by the discovery of a composition of dried free amino acids, peptides, and organic and inorganic nitrogen with anionic activity, although any source that will enhance dietary anionic activity can also be used. In the preferred embodiment of the invention, this composition is obtained from either glutamic acid fermentation solubles, corn fermentation solubles or a mixture thereof, although any source material that provides these fermentation solubles may be used. Common sources are byproducts derived from a fermentation of fungal or bacterial origin: including corn step liquor, corn distiller's solubles, and rye distiller's solubles. The source of the base materials is of less importance than the corn and/or glutamic acid fermentation solubles provided. A carrier, such as wheat middlings, can be included if desired and in view of the drying method used for any amount of carrier. Typical ranges (st/wt) of dried solubles to wheat middlings are from 10:1 to 1:10 including intermediate ratios. The carrier is preferably edible by the animal and a common feed ingredient. Either of these solubles alone or individually, and blended onto a carrier if needed, are suitable. The corn and glutamic acid fermentation solubles are mixed in any proportion either before or after drying, and optionally upon a carrier if mixed dry.

The one or more solubles are then dried to a maximum moisture content of about 30% at low temperature. Moisture contents of approximately 0% to 30% are acceptable. Drying methods include vacuum drying, direct and indirect heat, spray drying, evaporation, and the like. A forced air grain processor, otherwise useful to roast soybeans, is preferred. In each method, drying must occur at temperatures that modify the solubility of the nitrogen fractions without denaturing them.

In the preferred embodiment of the invention, glutamic acid fermentation solubles, corn fermentation solubles, or a blend of the two are dried using the previously described methods. These materials are then added to the diet of the animal at a rate depending upon the class of animal, for example in beef cattle the amount fed will be around ¼ to 1 lb; for swine, ⅛ to ½ lb; and, for poultry, 1/16 to ⅛ lb. The amount fed will vary with the dietary concentration of cations present, with more of the invention being fed in situations where the cation load is significant. Addition of the present invention can be mathematically determined by calculating the cation/anion balance of the diet using equations known to practioners of the art for this purpose. The objective is to add enough of the invention to provide a negative balance between cations and anions. This negative balance will vary with species but will range generally from (−)1 to (−)81 meq/kg of diet. The resulting diet is then fed to the fattening animal for a period of generally between 1 to 21 days prior to slaughter, with 14 days preferred. If alternative sources of anions are used such as ammonium salts, liquid glutamic acid fermentation solubles, liquid corn fermentation solubles or hydrochloric acid for example, feeding rates for these materials will vary based upon anionic source. Inclusion rates of these materials however are still governed by the need to produce a negative cation/anion balance as that described in the preferred embodiment of the invention.

The invention may be added to any feed fed to fattening animals, preferably to feeds comprising at least one grain byproduct, such as oilseeds and oilseed meals, corn grain, and small grains, to provide a supplemented feed. The amount added will generally range from about 0.10 lb to about 2 lbs per head per day, depending upon the method of application and species to be fed.

Having generally described this invention, a further understanding can be obtained by reference to certain specific examples which are provided herein for purposes of illustration only and are not intended to be limiting.

### EXAMPLE 1

### Preparation of the Feed Additive

The feed additive of the present invention is produced by mixing glutamic acid fermentation solubles and corn fermentation solubles at a ratio of 60/40 on a weight, weight basis upon a wheat middlings carrier on a 1.67 to 1 weight, weight basis of solubles to wheat middlings. These ratios can vary with the intended end product, or either of the components that make up the liquid blend can be used alone. The carrier may also be omitted if not desired or required by the drying process. The material is then exposed to forced air at temperatures not less than about 80° F., but not more than about 900° F., with a preferred range between about 190° F. and about 280° F., for a period of not less than about three minutes. This material is then cooled to about 90° F. and then about one third of this material is recycled and reblended, and again exposed to forced air temperatures not less than about 80° F., but not more than about 900° F. The material has a final moisture content of about 15% by weight based on total weight. This material can then be fed directly to the animal as part of its formulated ration, at a use rate dictated by species and intended dietary application.

### EXAMPLE 2

### An Investigation into the Effects on Beef Tenderness of the Feed Additive of the Present Invention

One hundred and twenty steers on feed were divided into two groups. The groups were then randomly assigned to treatments, and fed in ten head pens. Treatments were (1) invention feed additive supplementation (n=62 head), and (2) no controls (n=58). Those cattle supplemented with the invention feed additive received 1 lb per head per day, in a total mixed ration, for 14 days before harvest. Feedlot performance data were collected over the 14-day trial.

All cattle were harvested at a commercial processing facility. Following a 36-hour chilling period, actual and adjusted preliminary yield grade, marbling score, lean and skeletal maturity score, and percentages of kidney, pelvic and heart fat, as well as recorded hot carcass weight, and USDA Yield and Quality Grade were determined. Ribeye (Longissimus muscle) areas of carcasses were measured using a Computer Vision System (CVS) manufactured by Research Management Systems USA. Strip loins (Longissimus muscle) were collected from 59 carcasses during in-plant fabrication: 30 from carcasses of cattle fed the present invention and 29 from carcasses of control cattle. Steaks from each strip loin were aged for five different lengths of postmortem time (3, 7, 14, 21, and 28 days), after which all steaks were subjected to Warner-Bratzler shear force evaluation. All steak samples were freshly chilled and never frozen, cut one inch thick from the anterior end of the strip loin, and evaluated for shear force characteristics.

Strip loin steaks were cooked on an electric conveyor grill (model TBG-60, Magikitch'n, Quakertown, Pa.) to a target internal temperature of 158° F. Each steak was cooked at a constant time of 6 minutes and 35 seconds at a setting of 325° F. for the top and bottom heating platens. Peak internal temperature measurements were recorded for each steak using a hand held thermometer (model HH21, Omega Engineering, Inc., Stamford, Conn.). After cooking, each steak was cooled to room temperature, 72° F., and 6 to 9 cores (one half inch diameter) were removed from each steak parallel to the muscle fiber orientation. Each core was sheared perpendicular to the muscle fiber orientation, using an Instron testing machine fitted with a Warner-Bratzler Shear (WBS) head. Measurements of peak shear force were recorded and averaged to obtain a single shear force value for each steak.

Least squares means for feedlot performance, urine pH, and carcass data were computed using Mixed Model procedures, (SAS Inc., Cary, N.C.). In the model, treatment was included as a fixed effect, and initial bodyweight was included as a covariate to equalize initial variability in starting weight. Data from Warner-Bratzler shear force was tested using the Mixed Models procedure, supra, with a repeated measure analysis that included postmortem aging time, treatment, and ranch, the treatment by age interaction, and the treatment by ranch interaction. Postmortem aging time was treated as a repeated measurement.

As expected, the length of postmortem aging time influenced (P<0.001) Warner-Bratzler shear force values as in Table 1. Shear force values decreased from day 7 through day 28. An initial analysis of shear force values included aging periods of 3, 7, 14, 21, and 28 days in the model, and resulted in no differences between the feed additive supplemented steers and control steers. However, results from the analysis, including day 3 in the model, were very sensitive to the influences of tenderness at day 3 of aging; very little difference was observed in mean WBS values from carcasses of feed additive supplemented steers versus control steers at day 3, but a noticeable difference in WBS occurred between carcasses of treated versus control steers at later postmortem aging times. Therefore, further analyses were conducted in which WBS values for steaks aged only 3 days were omitted: revealing an overall treatment effect (P<0.03) in which feed additive supplemented steers generated steaks having lower shear force values than did control steers as in Table 2.

Platter et al. (2003) generated a formula that estimates the percentage change in overall acceptance of steaks by consumers using WBS force values. When means for steaks from feed additive supplemented steers versus controls were evaluated in the Platter et al. (2003) model, overall acceptance by consumers of steaks from control versus supplemented steers had a predicted decrease of 8.42%. Thus control steers were less desirable to consumers than treated steers. Furthermore, using pooled standard error values, a maximum decrease of 15% and a minimum decrease of 0.9% in consumer acceptance could be expected for steaks from control steers versus steaks from feed additive supplemented steers. Steaks from the feed additive supplemented steers would be expected to have greater acceptance among consumers of beef than steaks from control steers.

Supplementation of the invention feed additive to feedlot cattle 14 days prior to harvest resulted in significantly lower WBS force values for aging periods of 7, 14, 21, and 28 days.

This experiment clearly shows the value of the invention feed additive in increasing beef tenderness. Similar results would be expected in other meat animals such as swine and poultry. Although this experiment was conducted with the dried form of the preferred embodiment, similar results would be obtained using other sources of anions added to the diet of the fattening animal provided a similar negative balance of cation/anion was achieved.

This invention is unique in that prior to its discovery, all physiologic interventions known to practioners of the art, or ranchers, have proven ineffective in increasing meat tenderness. Only the invention feed additive significantly changed the rate of myofibrillar deterioration of postmortem muscle tissue: accelerating the aging process and enhancing it.

TABLE 1
Effects of Aging on Warner-Bratzler Shear Force Values

| | 7 day | 14 day | 21 day | 28 day | SEM | P |
|---|---|---|---|---|---|---|
| WBSF, | 4.46^{a} | 4.08^{b} | 3.47^{c} | 3.26^{d} | 0.099 | <0.001 |
| kg | | | | | | |

Superscript ^{a, b, c, d} means WBSF values in the same row that do not have a common superscript differ by P < 0.05.

TABLE 2
Effects of Invention Feed Additive on Warner-Bratzler Shear Force
Values

| | Invention Feed | Negative | | |
|---|---|---|---|---|
| | Additive | Control | SEM | P |
| WBSF, kg | 3.64^{b} | 3.99^{a} | 0.1570 | 0.0293 |

Superscript ^{a, b} means WBSF values in the same row that do not have a common superscript differ by P < 0.05.

1. An additive to livestock and poultry feed comprising:
one or more portions of fermentation solubles upon a carrier, said solubles upon said carrier mixed with regular livestock and poultry feed;
whereby said solubles make the livestock and poultry feed attain a more negative cation and anion balance;
whereby calpain activity accelerates in livestock and poultry carcasses following slaughter.

2. The feed additive of claim 1 further comprising:
said fermentation solubles having glutamic acid, corn, or other anionic solubles.

3. The feed additive of claim 2 further comprising:
said solubles in a ratio by weight with said carrier from approximately 10:1 to approximately 1:10 and a moisture content from approximately 0% to approximately 30%.

4. The feed additive of claim 3 wherein said additive is fed to cattle at a rate of approximately 0.25 lb to approximately 1 lb per head per day, to swine at a rate of approximately 0.125 lb to approximately 0.5 lb per head per day, and to poultry at a rate of approximately 0.0625 lb to approximately 0.125 lb per bird per day.

5. The feed additive of claim 4 wherein the negative balance ranges from approximately −1.0 meq/kg to approximately −81.0 meq/kg.

6. An additive to livestock and poultry feed comprising:
a mixture of approximately sixty percent by weight glutamic acid fermentation solubles and approximately forty percent by weight corn fermentation solubles;
said mixture being upon wheat middlings in a ratio of 1.67 to 1 by weight of said solubles to said middlings;
said mixture then drying at temperatures from approximately 80° F. to approximately 900° F. for a period of not less than three minutes;
said mixture is then cooled to approximately 90° F.;
one third of said mixture is then removed and recycled into said mixture and then dried at no less than approximately 80° F. and no more than approximately 900° F.; and,
said mixture attaining a final moisture content of approximately fifteen percent by weight;
whereby said solubles make the livestock and poultry feed attain a more negative cation and anion balance;
whereby calpain activity in livestock and poultry accelerates in carcasses following slaughter.

7. The feed additive of claim 6 wherein use of said additive reduces the Warner Bratzler shear force value to less than 4.5 kilograms in no less than seven days.
